(19) United States
(12) Patent Application Publication
(10) Pub. No.: US 2011/0009041 A1
(43) Pub. Date: Jan. 13, 2011

(54) FOOD CONDITIONER

(75) Inventors: JAMES SPISICH, Culpeper, VA (US); Sal Sparacino, Fairfax, VA (US); Wayne Spillner, Warrenton, VA (US); Charlie Degges, Manasss, VA (US); Lee Clarkson, Amissville, VA (US)

Correspondence Address: MCGUIREWOODS, LLP, 1750 TYSONS BLVD, SUITE 1800, MCLEAN, VA, 22102, US

(73) Assignee: Ross Industries, Inc., Midland, VA (US)

(21) Appl. No.: 12/830,935

(22) Filed: Jul. 6, 2010

Related U.S. Application Data
(60) Provisional application No. 61/223,566, filed on Jul. 7, 2009.

(51) Int. Cl. A22C 9/00

(52) U.S. Cl. 452/141

(57) ABSTRACT

A food conditioner having a primary guard that is configured to be removable and a drive train network that is configured to automatically unlatch when the primary guard is removed, wherein the primary guard includes a guard partition that forces engagement of a tapered coupling drive.

### CROSS REFERENCE TO PRIOR APPLICATIONS

This application claims priority and the benefit thereof from U.S. Provisional Application No. 61/223,566, filed Jul. 7, 2009, titled “Tabletop Tender-Cuber,” the entirety of which is hereby incorporated herein by reference.

### FIELD OF THE DISCLOSURE

The disclosure relates to an apparatus and a system for conditioning food products, including tenderizing food products such as, e.g., meats.

### BACKGROUND OF THE DISCLOSURE

Meat tenderizers are known in the industry. These devices are typically used to tenderize slabs of meat in preparation for cooking. The devices generally soften fibers in meat, making the meat easier to chew, and easier to digest. Tenderizers can be especially useful when preparing particularly tough cuts of, for example, steak, and work well when broiling or frying the meat. By opening incisions into the flesh, meat tenderizers can also accelerate cooking times.

Automated meat tenderizers tend to have major safety issues associated with their construction and operation. For example, some meat tenderizers are made using an acrylic primary top guard and a feed chute, which are known to be brittle and break often while in operation. In this regard, plastic shavings may find their way in tenderized meat products. Resultantly, unnecessary costs may be incurred, including replacement costs associated with replacing the broken guard. Furthermore, a broken guard may not be effective in preventing potential operator injuries and keeping air borne foreign material out of the discharged tenderized meat products.

Furthermore, automated meat tenderizers have major issues involving ON/OFF switches. For instance, many of these tenderizers use toggle switches instead of push-buttons. Unlike push-buttons, toggle switches may be actuated unintentionally, or the toggle switches may remain in an ON position when the tenderizer is unplugged, or power is otherwise terminated, resulting in a safety hazard when power is restored to the machine. While the tenderizers may include a sensor to stop the machine when a guard is dislodged or missing—if the switch is not turned off, the machine blade rotation resumes as soon as the guard is put back in position, whether an operator is prepared for this engagement of the blade drive or not.

An unfulfilled need exists for an apparatus that is configured to effectively and efficiently tenderize meat products, while ensuring operator safety and minimizing operational costs.

### SUMMARY OF THE DISCLOSURE

According to an aspect of the disclosure, a food conditioner is disclosed that may be used to score, tenderize, and perforate the surface and interior of, for example, a meat to accelerate cooking time and/or tenderize the processed meat, slit the meat into strips, or make tender cross hatch cube steaks using a knit blade setup that can interweave two or more pieces together into a single output piece of flesh.

According to an aspect of the disclosure, a food conditioner is disclosed that comprises: a primary guard that is configured to be removable; and a drive train network that is configured to automatically unlatch when the primary guard is removed, wherein the primary guard includes a guard partition that forces engagement of a tapered coupling drive. The food conditioner may further comprise: a cartridge assembly that is configured to separate from the food conditioner, wherein the cartridge assembly is spring-loaded, and wherein the cartridge assembly is further configured to engage the coupling drive under force from the guard partition. The guard partition may comprise an angled wedge portion that temporarily contacts a portion of the cartridge assembly when the primary guard is removed from or installed in the food conditioner. The cartridge assembly may comprise a pair of matched blade assemblies. The cartridge assembly may comprise at least one of: a tenderizing blade assembly; a scoring blade assembly; a cutting blade assembly; a traction knit cubing blade assembly; and a traction blade assembly. The at least one of the pair of matched blade assemblies may comprise a cartridge shaft having a tapered end to engage the coupling drive. The coupling drive may comprise at least one drive shaft having a tapered end. The cartridge assembly may comprise a cartridge base, which may comprise a pusher pin that is configured to store potential energy when the cartridge assembly is in a substantially operational position and release the potential energy when the primary guard is moved from a substantially operational position.

The food conditioner may further comprise a controller that is configured to cease supply of power to a drive motor when the primary guard is moved from a substantially operational position. The food conditioner may further comprise a magnet assembly that is configured to detect when the primary guard is moved from the substantially operational position. Still further, the food conditioner may comprise a read switch and magnet assembly that is configured to detect when the primary guard is moved from the substantially operational position and send a signal to the controller.

According to a further aspect of the disclosure, a food conditioner is disclosed that comprises: a removable primary guard that includes a chute which is configured to receive a product; a cartridge assembly that includes a pair of matched blade assemblies that are configured to receive the product from the chute; and a drive train that is configured to automatically unlatch when the primary guard is removed, wherein the primary guard includes a guard partition that forces engagement of a tapered coupling drive, and wherein the cartridge assembly is further configured to engage the coupling drive under force from the guard partition. The guard partition may comprise an angled wedge portion that temporarily contacts a portion of the cartridge assembly when the primary guard is removed from or installed in the food conditioner. The at least one of the pair of blade assemblies may comprise a cartridge shaft having a tapered end to engage the coupling drive. The coupling drive may comprise at least one drive shaft having a tapered end. The cartridge assembly may comprise a cartridge base, which includes a pusher pin that is configured to store potential energy when the cartridge assembly is in a substantially operational position and release the potential energy when the primary guard is moved from a substantially operational position.

The food conditioner may further comprise a controller that is configured to cease supply of power to a drive motor when the primary guard is moved from a substantially operational position. Further, the food conditioner may comprise a magnet assembly that is configured to detect when the primary guard is moved from the substantially operational position.

According to a still further aspect of the disclosure, a food conditioner is disclosed, comprising: a housing configured to receive a primary guard and a cartridge assembly, which includes a pair of matched blade assemblies; and a drive train network that includes a coupling drive which is configured to automatically unlatch from the cartridge assembly when the primary guard is removed. The at least one of the pair of matched blade assemblies may be selected from: a tenderizing blade assembly; a scoring blade assembly; a cutting blade assembly; a traction knit cubing blade assembly; and wherein the drive train network comprises a keyed washer.

Additional features, advantages, and embodiments of the disclosure may be set forth or apparent from consideration of the following attached detailed description and drawings. Moreover, it is to be understood that both the foregoing summary of the disclosure and the following attached detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows a perspective view of a food conditioner, according to principles of the disclosure;

FIG. 2 shows a bottom perspective view of the food conditioner of FIG. 1;

FIG. 3 shows a front view of the food conditioner of FIG. 1;

FIG. 4 shows a cross-section side view of the food conditioner of FIG. 1 cut along a reference plane A-A;

FIG. 5 shows another cross-section side view of the food conditioner of FIG. 1 cut along a reference plane B-B;

FIG. 6 shows a side view of the food conditioner of FIG. 1;

FIG. 7 shows a cross-section view of the food conditioner of FIG. 1 cut along a reference plane E-E;

FIG. 8 shows a cross-section view of the food conditioner of FIG. 1 cut along a reference plane F-F;

FIG. 9 shows an exploded view of an example of a guard assembly that may be used in the food condition of FIG. 1, according to principles of the disclosure;

FIG. 11 shows a detailed view of a coupling section shown in FIG. 10;

FIG. 12 shows a perspective view of an example of a drive shaft, according to principles of the disclosure;

FIG. 13 shows a perspective, partial view of a cartridge shaft, according to principles of the disclosure

FIG. 14 shows a front view of the food conditioner of FIG. 1 with a guard assembly removed, showing a cut-away view of a section of the cartridge assembly and an inner wall of a processing area;

FIG. 15 shows a detailed view of the cut-away view shown in FIG. 14;

FIG. 16 shows a front view of the food conditioner of FIG. 1 with the guard assembly installed;

FIG. 17 shows a detailed view of a cut-away view C in FIG. 16;

FIG. 18 shows a perspective view of an example of a cartridge assembly, according to principles of the disclosure;

FIG. 19 shows an exploded view of the cartridge assembly of FIG. 18;

FIG. 20 shows a perspective view of a traction knit cubing blade assembly that may be used with the cartridge assembly of FIG. 18, according to principles of the disclosure;

FIG. 21 shows a perspective bottom view of the traction knit cubing blade assembly of FIG. 20;

FIG. 22 shows an exploded view of the traction knit cubing blade assembly of FIG. 20;

FIG. 23 shows an exploded view of a traction knit cubing blade that may be used in the traction blade assembly of FIG. 20, according to principles of the disclosure;

FIG. 24 shows an example of a traction knit cubing blade that may be used in the traction blade shaft assembly of FIG. 23, according to principles of the disclosure;

FIG. 25 shows an alternative example of the slitter knit cubing blade that may be used in the traction blade shaft assembly of FIG. 23, according to principles of the disclosure;

FIG. 26 shows a perspective bottom view of an example of a rotary cutting blade assembly that may be used in the cartridge assembly of FIG. 18 with a traction knit cubing blade set on an opposing cartridge, according to principles of the disclosure;

FIG. 27 shows an exploded view of the cutting blade assembly of FIG. 26;

FIG. 28 shows an exploded view of a cutting blade that may be used in the cutting blade assembly of FIG. 26, according to principles of the disclosure;

FIG. 29 shows a perspective view of a cartridge base that may be used in the cartridge assembly of FIG. 18, supporting all of the available matched blade sets, according to principles of the disclosure;

FIG. 30 shows an exploded view of the cartridge base of FIG. 29;

FIG. 31 shows an exploded view of an example of a gearbox assembly that may be used in the food conditioner of FIG. 1, according to principles of the disclosure;

FIG. 32 shows a process logic decision tree for safety enabling/disabling power supply to a motor circuit in the food conditioner of FIG. 1, according to principles of the disclosure; and

FIG. 33 shows an example of sequential process for cleaning a cutting blade assembly or a traction blade assembly, according to principles of the disclosure.

The present disclosure is further described in the detailed description that follows.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments, as one of ordinary skill in the art would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

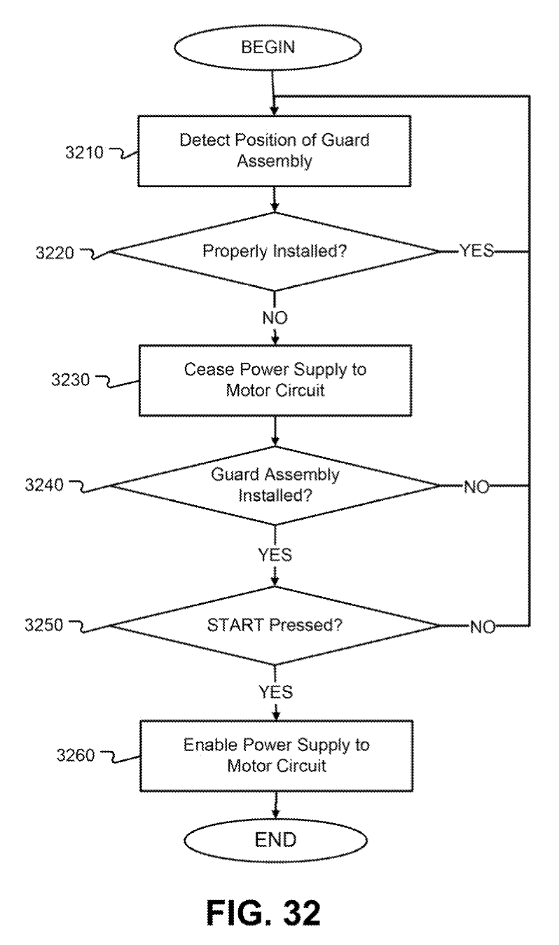

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a PLC, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like. Further, the computer may include an electronic device configured to communicate over a communication link. The electronic device may include, for example, but is not limited to, a mobile telephone, a personal data assistant (PDA), a mobile computer, a stationary computer, a smart phone, mobile station, user equipment, or the like. Manipulation of some data can be accomplished so simply that relay logic can be used to satisfy, for example, the process shown in FIG. 32.

A “computer-readable medium”, as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

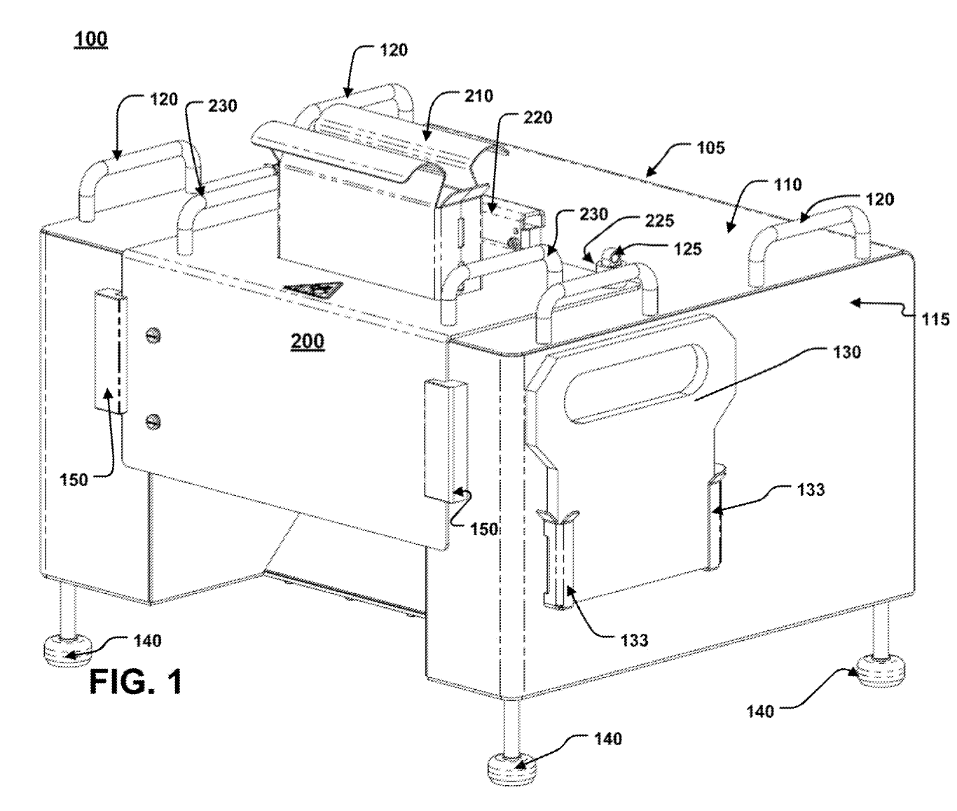

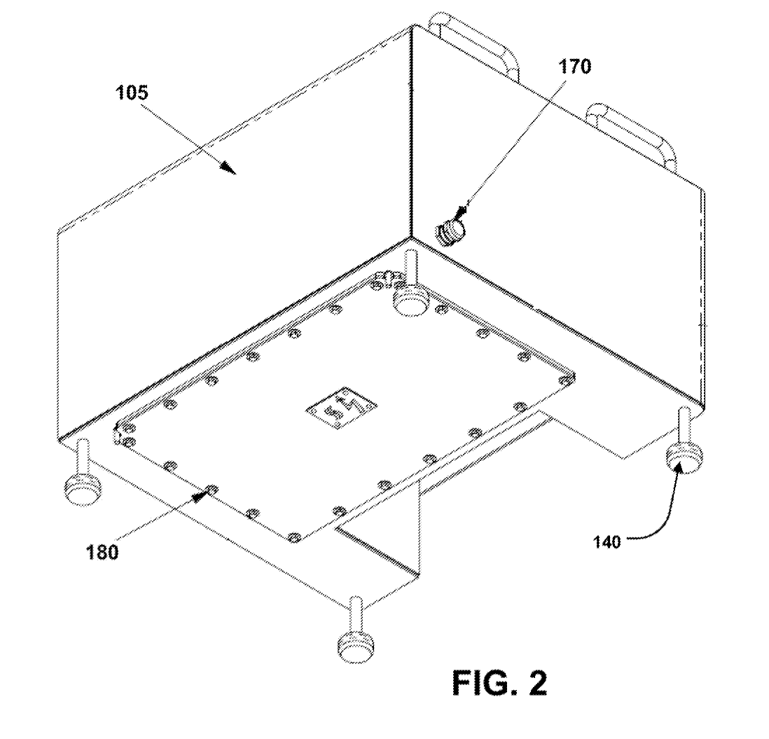

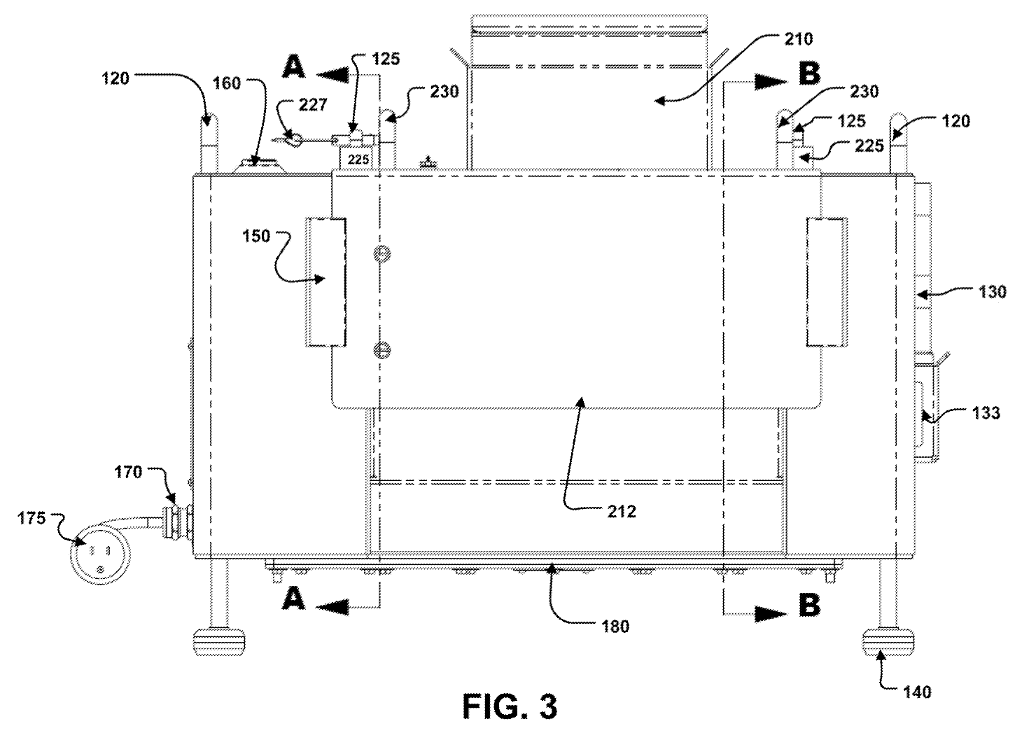

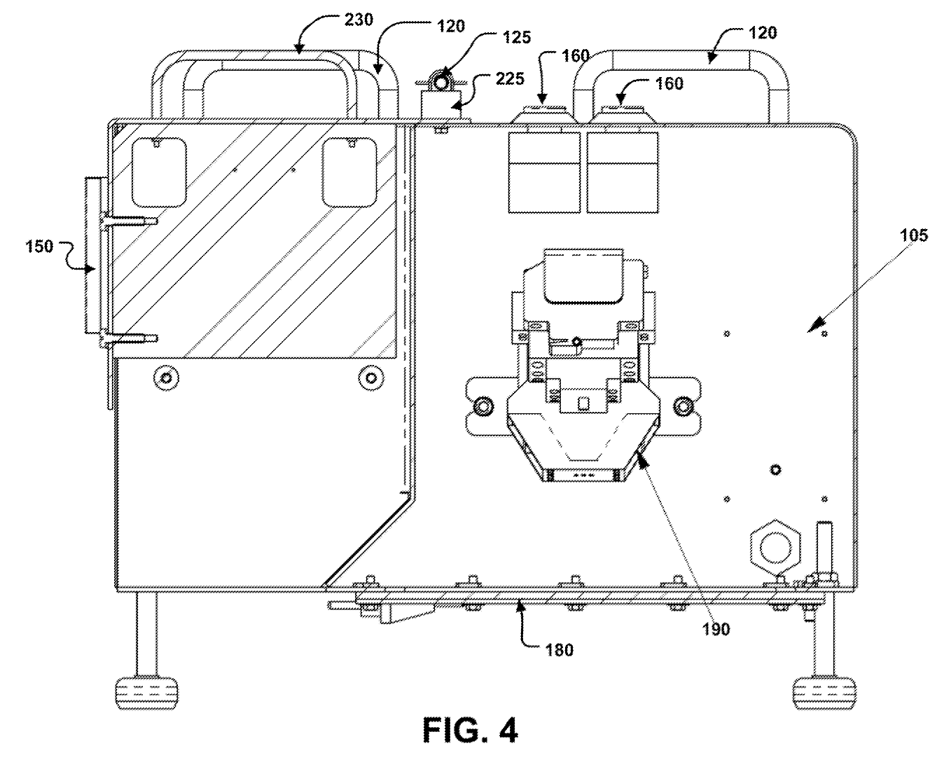

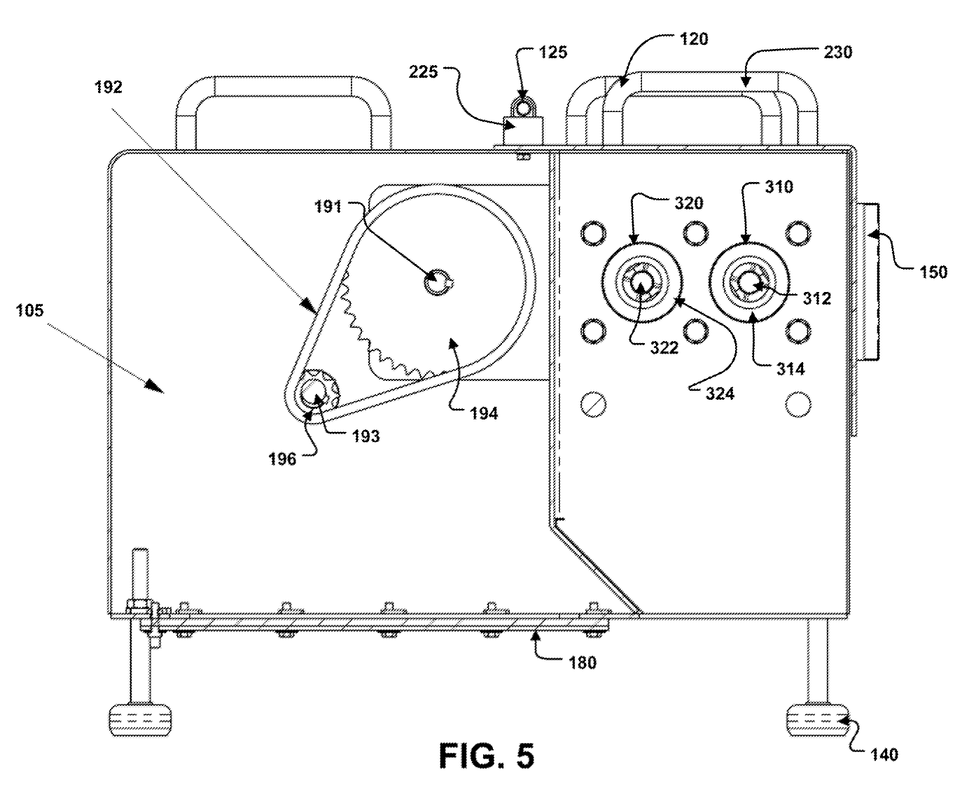

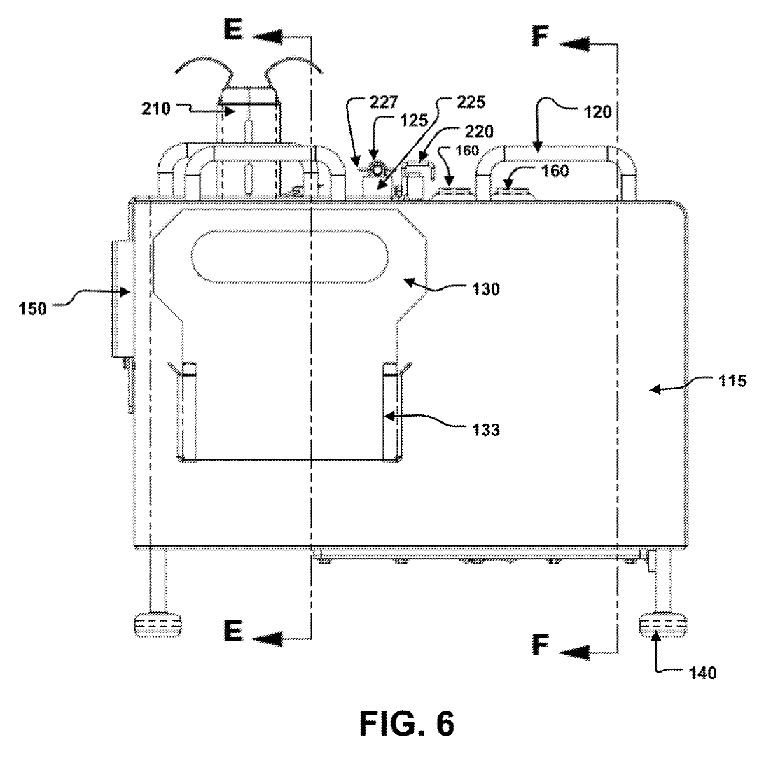

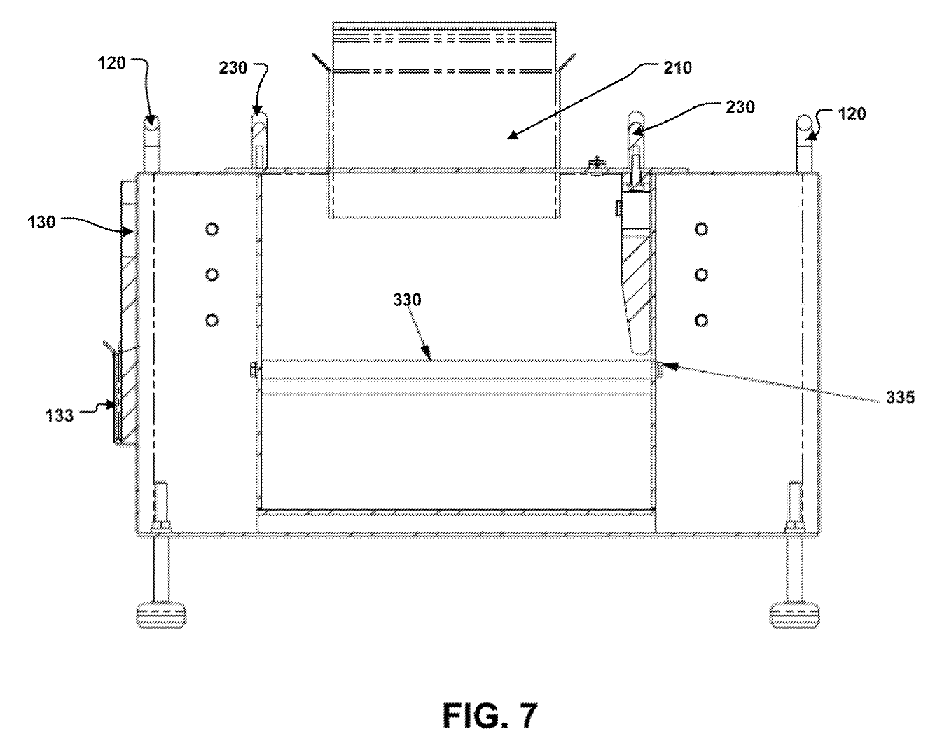

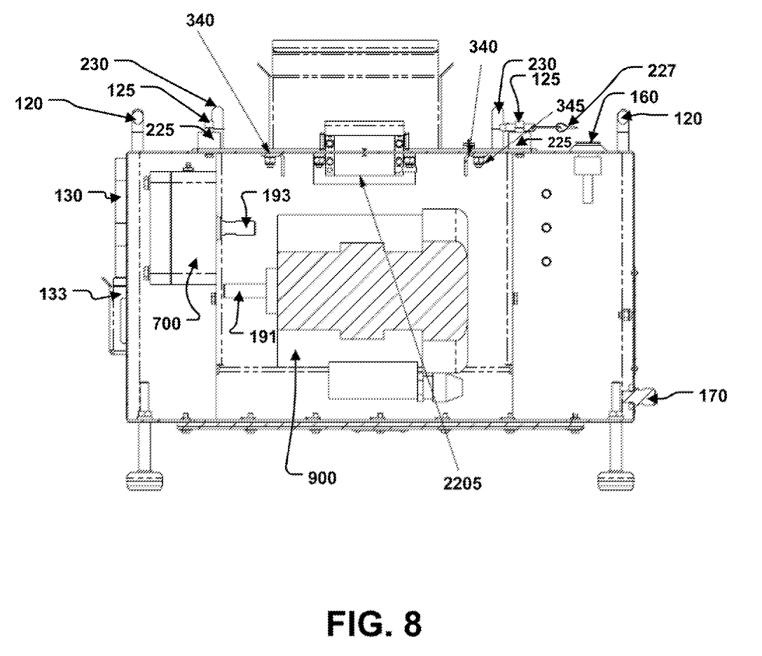

FIGS. 1-8 show various views of an example of a food conditioner 100, according to principles of the disclosure. In particular, FIG. 1 shows a perspective view of the food conditioner 100; FIG. 2 shows a bottom perspective view of the food conditioner 100; FIG. 3 shows a front view of the food conditioner 100; FIG. 4 shows a cross-section side view of the food conditioner 100 cut along a reference plane A-A (shown in FIG. 3); FIG. 5 shows another cross-section side view of the food conditioner 100 cut along a reference plane B-B (shown in FIG. 3); FIG. 6 shows a side view of the food conditioner 100; FIG. 7 shows a cross-section view of the food conditioner 100 cut along a reference plane E-E (shown in FIG. 6); and FIG. 8 shows a cross-section view of the food conditioner 100 cut along a reference plane F-F (shown in FIG. 6). The food conditioner 100 is configured to tenderize meat products, including, for example, cutting through sinew, whole muscle and other connective tissue that may render the meat products tough.

Referring to FIGS. 1-8, the food conditioner 100 includes a housing 105 and a removable guard assembly 200. The housing 105 may include a plurality of sides, including a top 110 and a side 115. The food conditioner 100 may include a plurality of handles 120, one or more guard guide posts 125, a pusher 130, a plurality of legs 140, a plurality of panel guides 150, one or more actuators 160, a power supply connector 170, a power supply receptacle 175, a base assembly 180, and an electrical assembly 190. As seen, the plurality of handles 120, the guard guide posts 125, the panel guides 150, and the actuators 160, or parts thereof, may be affixed to, or integrally formed with, for example, the top 110 of the housing 105. The handles 120 are configured to be grasped by hands to facilitate movement of the food conditioner 100. The base assembly 180 may include, for example, a perimeter gasket that allows the food conditioner 100 to be sprayed down as a preliminary cleaning method without adversely impacting the drive parts, including the sealed gearbox assembly 700.

Either (or both) of the guard guide posts 125 may be configured to engage and guide a respective guard guide 225 provided on the guard assembly 200 to ensure proper alignment of the guard assembly 200 as it is placed in to the food conditioner 100. The panel guides 150 may further assist in providing proper alignment of the guard assembly 200 as it is replaced in the food conditioner 100. The guard guide post(s) 125 may include an opening for receiving a quick release pin 227, which may be attached to a lanyard (shown in FIG. 2), and an opening, for example, for receiving a lock/hasp to lock or tag the food conditioner 100. For instance, the opening in the guide post 125 on one side may accommodate an operation's safe tag-out procedure by accommodating a lock (not shown), instead of a quick release pin 227, since one retaining quick release pin 227 may be sufficient to hold the guard assembly 200 in place. The quick release pin 227 may help to secure the guard assembly 200 in the food conditioner, maintaining proper positioning of the guard assembly 200.

The pusher 130 may be supported by, for example, a pair of pusher guides 133 provided on the side 115 of the housing 105. The pusher 130 is configured to be handled by, for example, a single hand (or both hands) to force, e.g., a meat product through a chute 210 into the food conditioner 100, for example, to clear any jams that may occur. The pusher 130 may be made of an approved plastic material for use in a food zone (e.g., ANSI [NSF] standards compliant). Use of the pusher 130 may virtually eliminate the need to remove the guard assembly 200 to clean any product jams, as the drive scheme and traction blades 4100, 4200 work together with the pusher 130 to make the rotary cartridge blade sets self-clearing.

Each of the legs 140 may include a height-adjustable leg with, for example, a high-friction base to prevent the food conditioner 100 from sliding when placed on a surface, such as, for example, a table top. For example, the base may include material such as rubber, plastic, silicone, or the like.

The guides 150 are configured to receive and guide the front panel 212 of the guard assembly 200 to ensure proper alignment. The guides 150 are also configured to hold the front panel 212 securely to the food conditioner 100.

The actuator(s) 160 may include, for example, a depressible switch, a key switch, a toggle switch, or the like, or any combination thereof. The actuators 160 may be configured to enable/disable the supply of power to a driver motor (not shown) to control operation of the food conditioner 100. Furthermore, the actuators 160 may be configured to control an operation mode of the food conditioner 100, such as, for example, a direction of the driver motor, a speed of the driver motor, or the like. In the preferred embodiment, the actuators 160 include a green “START” pushbutton and a red “STOP” pushbutton.

The power supply receptacle 175 may be configured to be coupled to a common power supply outlet to supply power to the electrical assembly 190, as understood by those of ordinary skill in the art. The power supply receptacle 175 may be configured to receive an alternating current (AC) or a direct current (DC) electric power supply, including, for example, 115 VAC/60 Hz, 230 VAC/60 Hz, 230 VAC/50 Hz, or the like. A preferred embodiment of the food conditioner 100 may be configured to receive 115 VAC/60 Hz for North America and 200-240 VAC/50 Hz for international applications.

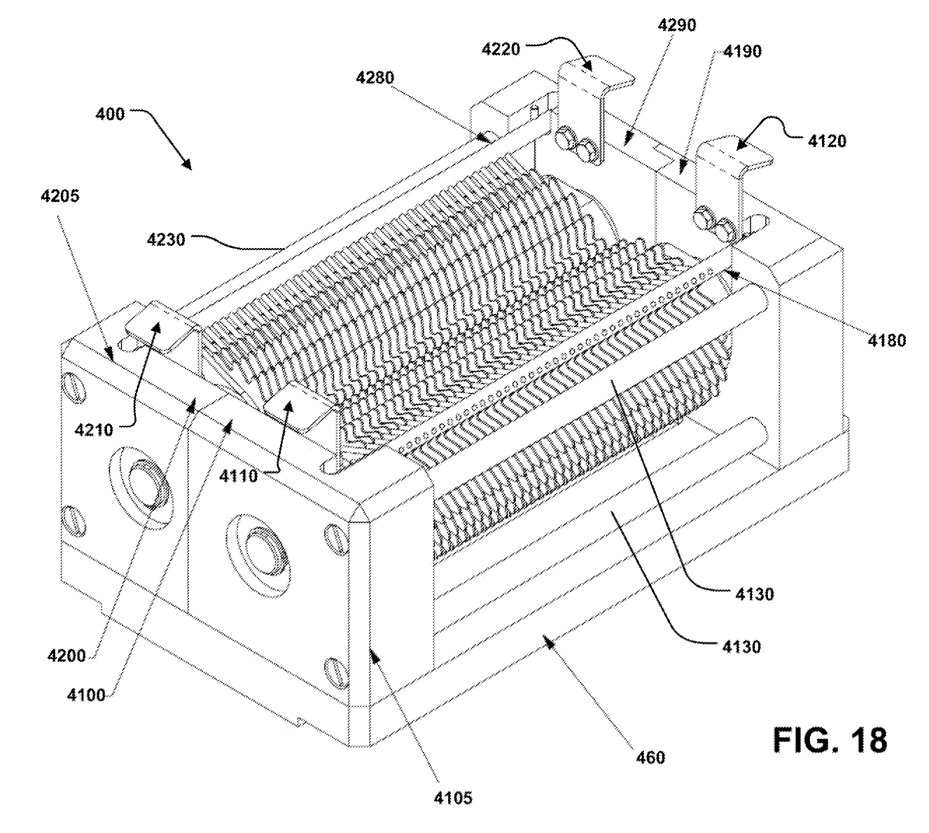

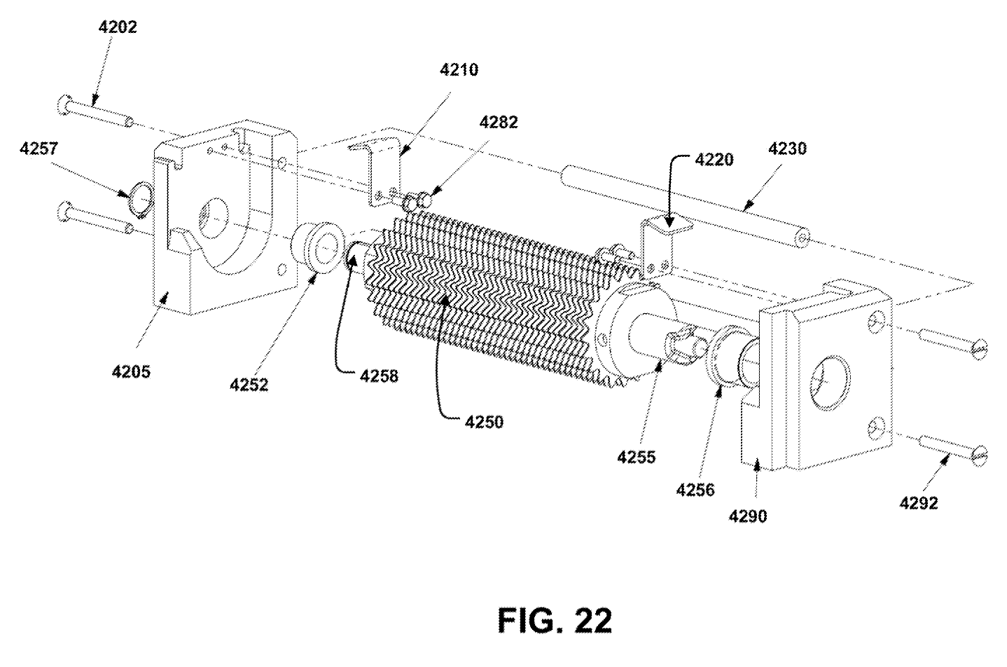

Referring to FIG. 5, the food conditioner 100 comprises a drive train that is driven by a driver motor (shown in FIG. 8). The drive train may include a pair of sprockets (or, e.g., pulleys) 194, 196 of different diameters mounted to drive shafts 191, 193, respectively, and a drive chain (or belt) 192. The drive chain 192 may include, for example, a roller chain, a steel belt, a serpentine belt, a silent chain, a timing belt, or the like. The drive shaft 191 may be coupled to (or a part of) an electric motor 900 (shown in FIG. 8). The drive shaft 193 may be coupled to (or a part of) a gearbox assembly 700 (shown in FIG. 8). The food conditioner 100 further comprises a pair of drive shaft couplers 310, 320 for coupling to and driving a blade assembly 400 (shown in FIG. 18). The drive shaft coupler 310 may include, for example, a drive shaft 312 and a guide (e.g., a substantially frictionless ring, bearings, or the like) 314. Similarly, the drive shaft coupler 320 may include, for example, a drive shaft 322 and a guide (e.g., a substantially frictionless ring, bearings, or the like) 324. The motor 900 may be, for example, a single ½ HP motor, which may be stepped down with an about 4:1 chain drive to the stationary gear box assembly 700. The gear box assembly 700 may further step down the motor 4:1 and reverse the direction of an opposing cutting blade 4150 and a traction blade 4250 (shown in FIGS. 22, 27) (also considered to be right and left or front and back matched driving cartridge assemblies), so that the opposing blades can pull a product through the top and release the product under the cartridge assembly 400.

The blade assemblies 4150, 4250 (right/left or front/back cartridge assemblies 4150/4250) are separately driven with an interlocking end plate corner that holds the assemblies together, while allowing easy disassembly (or assembly) of the cartridge assembly 400 for cleaning or removing product jams.

FIG. 6 shows a side 115 view of the food conditioner 100, with reference planes E-E and F-F.

Referring to FIG. 7, which shows the cross-section view of the food conditioner 100 cut along the reference plane E-E, the food conditioner 100 includes a cartridge assembly support member 330. The cartridge assembly support member 330 may include, for example, a rod that is fastened to the housing 105 by means of a fastener 335, such as, for example, a bolt, a nut, a screw, or the like. The cartridge assembly support member 330 is configured to support the cartridge assembly 400 when it is placed in the food conditioner 100.

Referring to FIG. 8, which shows the cross-section view of the food conditioner 100 cut along the reference plane F-F, the food conditioner 100 includes the gearbox assembly 700, the motor 900, and a plurality of braces 340, which may fastened to the guard assembly 200 by means of a fasteners 345 (e.g., screws, bolts, nuts, rivets, or the like). Further, the food conditioner includes a read switch and magnet assembly 2205, which is configured to interact (for example, through magnetic coupling) with a magnet assembly 220 on the guard assembly 200, for example, to detect removal or improper alignment of the guard assembly 200 with regard to the food conditioner 100.

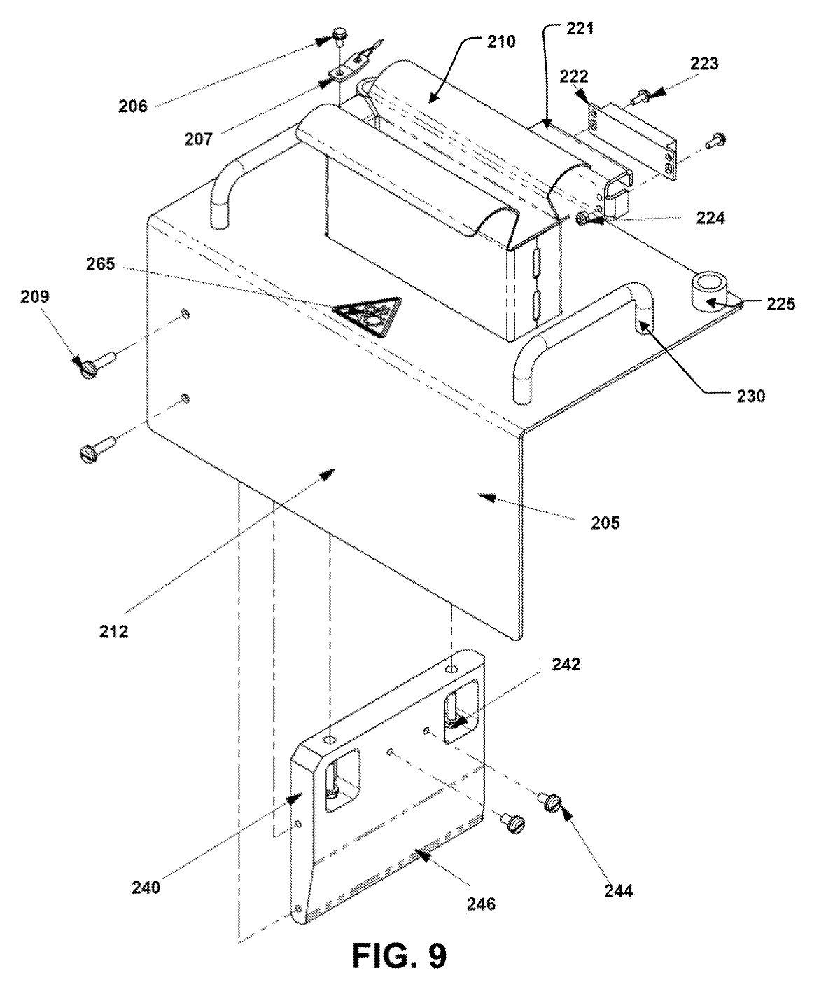

FIG. 9 shows an exploded view of an example of a guard assembly 200, according to principles of the disclosure. The guard assembly 200 may perform at least three functions, including, for example, a product chute, a safety interlock, and a mechanical engagement. The guard assembly 200 may include an L-shaped body 205, the chute 210, the magnet switch assembly 220, the handles 230, the guard guides 225, and a guard wedge (or partition) 240. The guard assembly 200 is removably aligned and secured to the food conditioner 100 by means of the guide posts 125 and the guard wedge 240. The body 205 may include a marking 265, such as, for example, a gear hazard sign, that may be centered with regard to the chute 210.

The chute 210, which may comply with, for example, EN294 specifications, may have a single point of engagement that may be sized so that an operator cannot reach an entanglement zone of the rotating blades. The chute 210 may open up after the single point to facilitate product free fall. The chute 210 may include an angled entry that has a small contact area at the entry point and a throat restriction that opens up so larger products may freely fall into a cartridge assembly 400 (shown in FIG. 6) of the food conditioner 100.

The magnet switch assembly 220 may include a bracket 221 and a coded magnet 222. The bracket 221 may be attached to, or integrally formed with the body 205. The magnet 222 may be affixed to the bracket 221 by means of an adhesive or by means of fasteners 223, 224, which may include, for example, screws, bolts, nuts, or the like. The magnet switch assembly 220 is configured to interact with the read switch and magnet assembly 2205 (shown in FIG. 8) to facilitate detection of removal or improper alignment of the guard assembly 200 with regard to the food conditioner 100. The read switch magnet assembly 2205 may be coupled to a controller (not shown) that is configured to cease the supply of power to the motor circuit (not shown) and to prevent the food conditioner 100 from being powered while the guard assembly 200 remains removed from, or improperly placed in the food conditioner 100. The controller may include a computer. The controller (not shown) may be included in the read switch and magnet assembly 2205. The controller (not shown) may be further configured to prevent automatic re-start of the food conditioner 100 when the guard assembly 200 is replaced, until, for example, the “START” actuator 160 is depressed.

The guard assembly 200 may include a lanyard support bracket 207 fastened to the body 205 by means of a fastener 206 (e.g., a screw, a nut, a bolt, a pin, or the like). The guard wedge 240 may be attached to the body 205 by means of a plurality of fasteners 209 (e.g., screws with washers, bolts with washers, nuts, pins, or the like) and 206. For example, the guard wedge 240 may be securely attached to the front panel 212 by means of the fasteners 209 and to the top side by means of the fasteners 206. The guard wedge 240 may include, for example, a plurality of fasteners 242 for engaging the fasteners 206. The guard wedge 240 may be further secured to the body 205 by means of additional fasteners 244. The guard wedge 240 may include a wedge portion 246 to facilitate easier alignment of the guard assembly 200 with regard to the food conditioner 100, as well as coupling (or decoupling) of the cartridge assembly 400 to the food conditioner 100. With the guard wedge 240 not locking the cartridge assembly 400 drive train in an engaged configuration, a spring disengages the drive and inertia quickly dissipates the blade rotary motion, thereby protecting the operator.

FIG. 10 shows a front view of the food conditioner 100 with the guard assembly 200 removed to show a cartridge assembly 400 provided in a processing area 185 of the food conditioner 100. The cartridge assembly 400 is coupled to the food conditioner 100 through a drive train network at a coupling section 187, which includes the drive shaft couplers 310, 320 (shown in FIG. 5). The cartridge assembly 400 includes a plurality of blade assemblies, including a cutting blade assembly 4100 and a traction blade assembly 4200, and a cartridge base 460. The cutting blade assembly 4100 may include guide handles 4110, 4120, and the traction blade assembly 4200 may include guide handles 4210, 4220 (shown in FIG. 18) to facilitate removal (or replacement) of the cartridge assembly 400 from (or into) the processing area 185. The guide handles 4110, 4120, 4210, 4220 may be configured to engage one or more channels (not shown) that may be provided on the underside of the body 205 to properly align and secure the cartridge assembly 400 in the food conditioner 100.

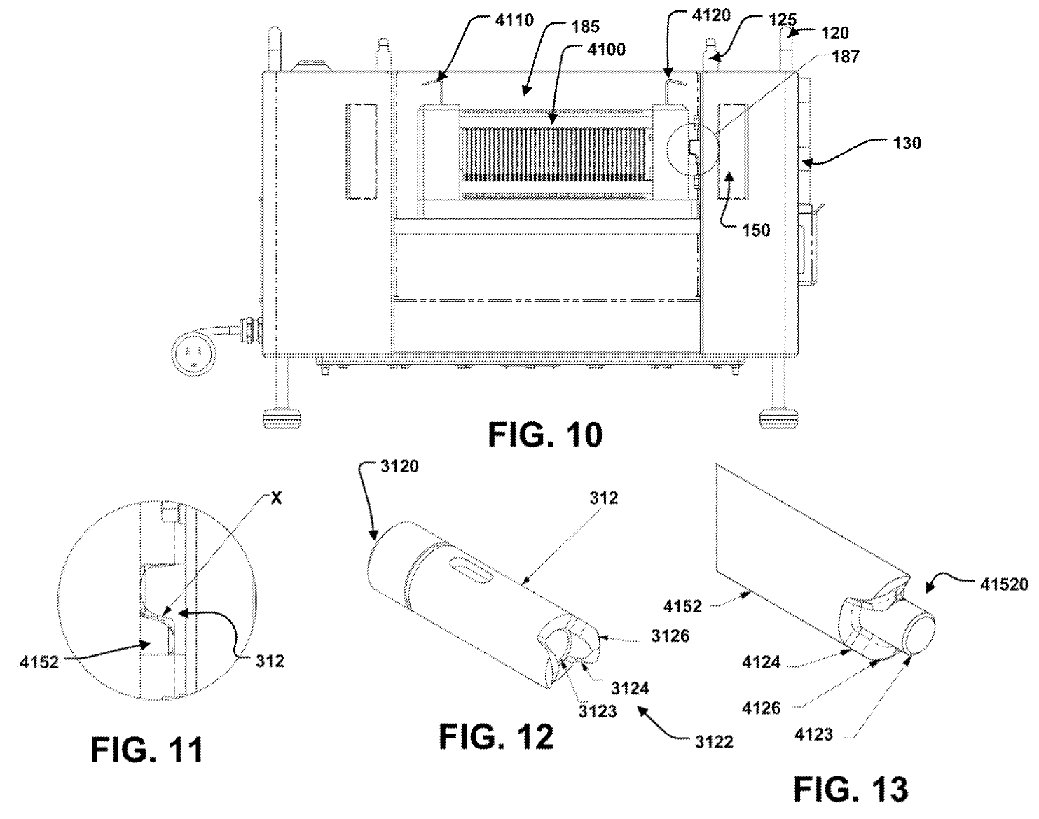

FIG. 11 shows a detailed view of the coupling section 187 shown in FIG. 10. The drive shaft 312 (shown in FIG. 5) may be coupled to a cartridge shaft 4152 of the front blade assembly 4100, as denoted by the arrow “X”. Similarly, the drive shaft 322 (shown in FIG. 5) may be coupled to a cartridge shaft 4255 (shown in FIG. 22) of the traction blade assembly 4200.

FIG. 12 shows a perspective view of an example of the drive shaft 312, according to principles of the disclosure. The drive shaft 322 may be similarly or identically configured. The drive shaft 312 includes one end 3120 that may be provided in the gearbox assembly 700 (shown in FIG. 8) and another, opposite end 3122 that is provided in the drive shaft coupler 310 in the coupling section 18 for engaging an end 41520 of the cartridge shaft 4152 (shown in FIG. 13). Similarly, the drive shaft 322 includes one end (not shown) that may be provided in the gearbox assembly 700 and another, opposite end (not shown) that is provided in the coupling section 187 for engaging an end of the cartridge shaft 4255 (shown in FIG. 22).

FIG. 13 shows a perspective, partial view of the cartridge shaft 4152, according to principles of the disclosure. It is noted that the cartridge shaft 4255 may be similarly or identically configured.

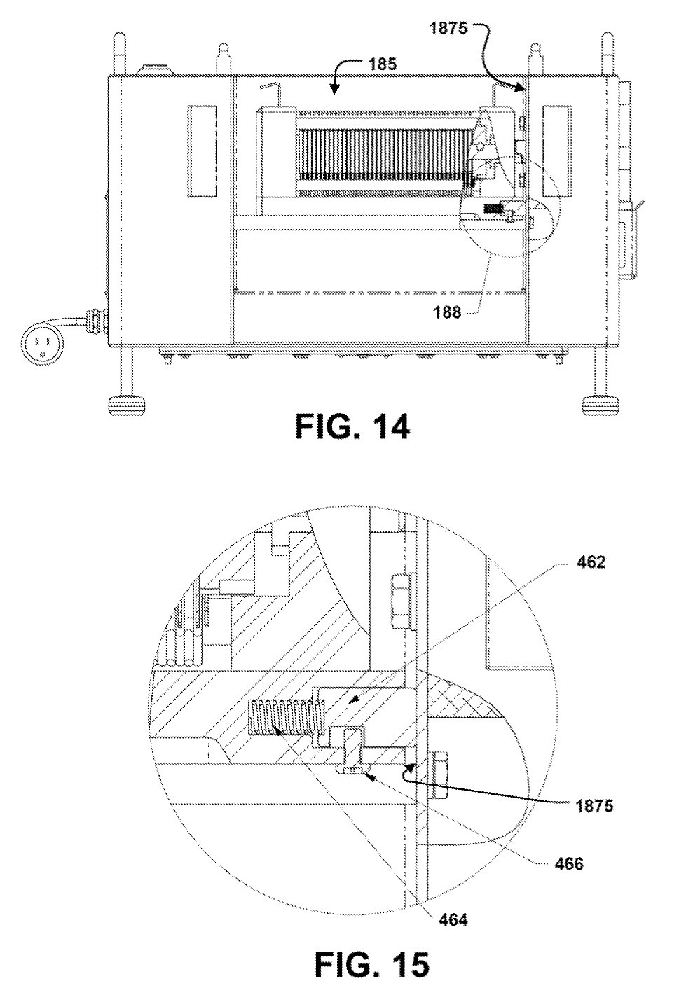

Referring to FIGS. 12 and 13, the drive shaft 312 may include a female pilot hole 3123 that may be configured to receive and locate a male pilot pin 4123 on the cartridge shaft 4152. The drive shaft 312 may further include a tapered tooth engagement portion 3124 that may be configured to engage a tapered tooth engagement portion 4124 on the cartridge shaft 4152. A radius of an extending portion 3126 of the drive shaft 312 and a radius of a corresponding extending portion 4126 of the cartridge shaft 4152 may be configured to decrease disengagement (or engagement) time between the drive shaft 312 (or 322) and the cartridge shaft 4152 (or 4255). The tapered portions 3124, 4124, and the radii of the extending portions 3126, 4126 facilitate a linear force to push the cartridge assembly 400 away from an inner wall 1875 (shown in FIG. 15) of the processing area 185, thereby providing for quick and easy removal (or installation) of the cartridge assembly 400 from (or to) the processing area 185 of the food conditioner 100.

FIG. 14 shows a front view of the food conditioner 100 with the guard assembly 200 removed, showing a cut-away view of a section 188 of the cartridge assembly 400 and the inner wall 1875 of the processing area 185.

FIG. 15 shows a detailed view of the section 188 of the cartridge assembly 400. As seen, the cartridge assembly 400 includes a spring pin 462 and a spring 464 that may be preloaded against the wall 1875 of the processing area 185 when the cartridge assembly 400 and guard assembly 200 are installed. The cartridge assembly 400 may further include a spring pin stroke limiter 466 to prevent the spring pin 462 from “popping out” of its housing.

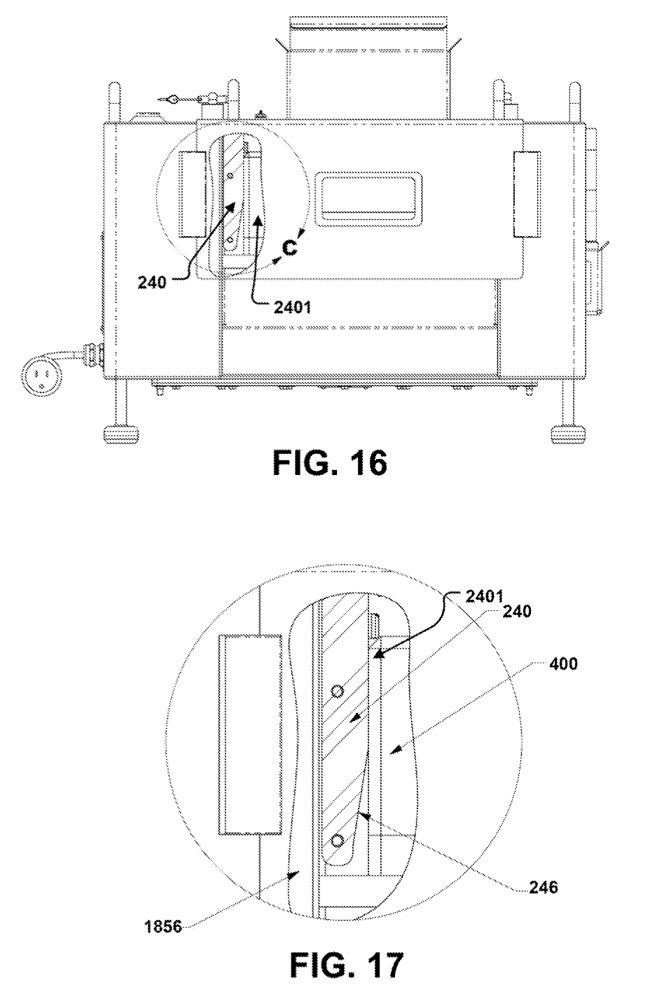

FIG. 16 shows a front view of the food conditioner 100 with the guard assembly 200 installed, showing a cut-away view C of the guard wedge 240 positioned against an end 2401 of the cartridge assembly 400.

FIG. 17 shows a detailed view of the cut-away view C in FIG. 16. As seen, the guard wedge 240 is positioned between a wall 1856 of the processing area 185 and the edge 2401 of the cartridge assembly 400. The wedge portion 246 of the guard wedge 240 may include a tapered lead angle to ease preloading of the spring pins 462 (shown in FIG. 15).

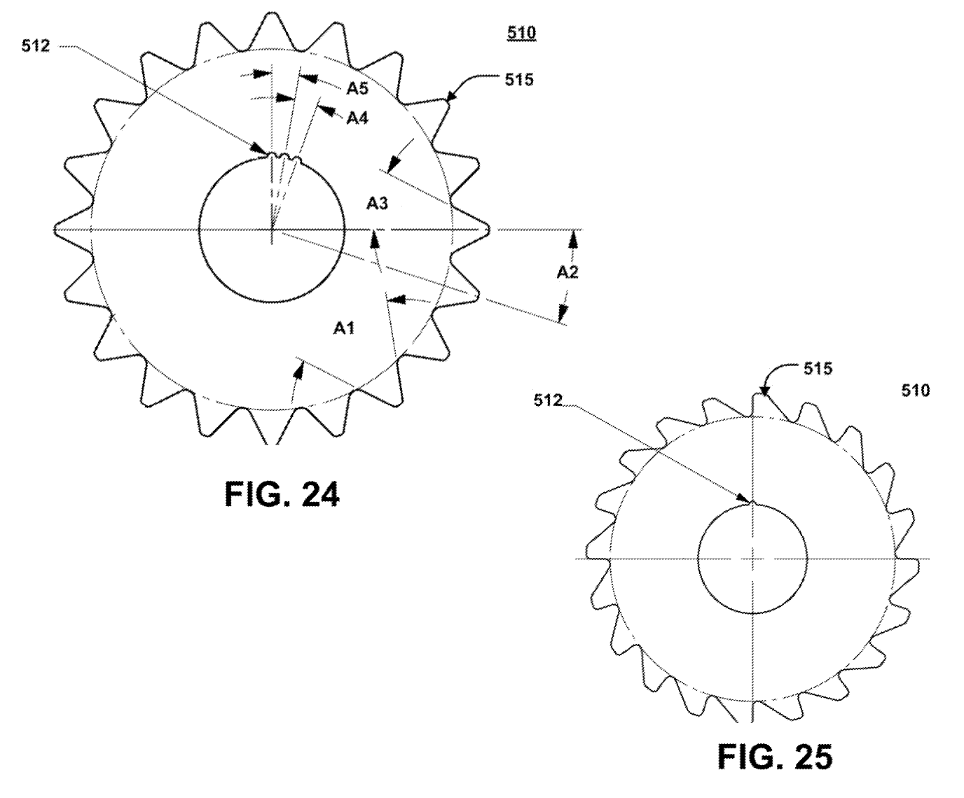

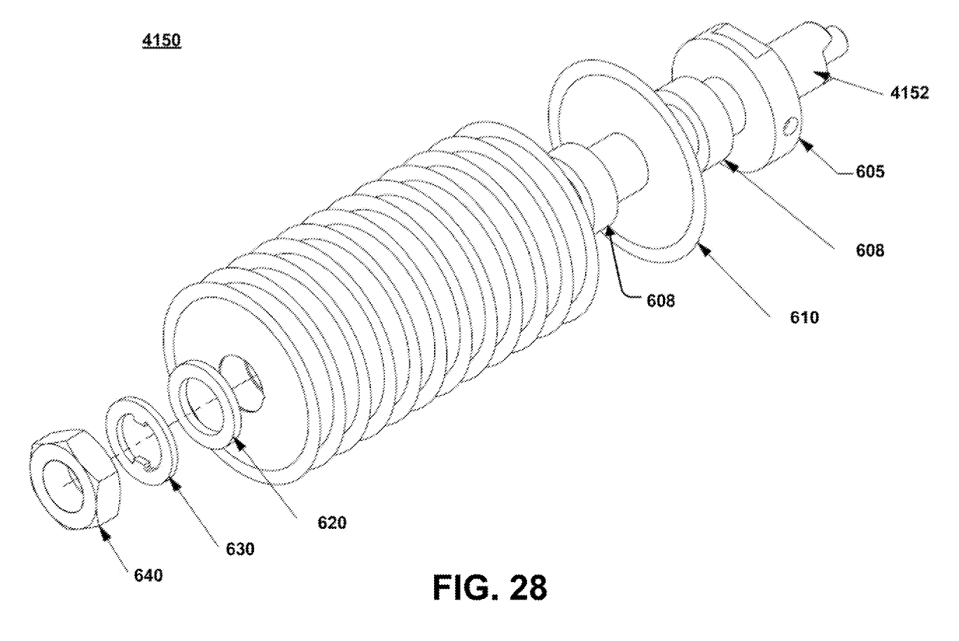

FIG. 18 shows a perspective view of an example of a cartridge assembly 400 equipped with blades, according to principles of the disclosure. The food conditioner 100 and cartridge assembly 400 may accommodate various different styles of blade assemblies, including different blade configurations, based on the desired performance of the cartridge assembly 400, including varying operational requirements of the end user's processing operation. For example, the cartridge assembly 400 may include: a knit cartridge (not shown) that may include a heavy, medium, or light level of tenderization; a strip cutting cartridge (e.g., as shown in FIG. 18); a scoring cartridge (not shown) that is configured to penetrate the surface of the product, or the like. In this regard, different configurations for the traction knit cubing blades 510 (e.g., shown in FIG. 24) and/or the slitter cutting blades 610 (e.g., shown in FIG. 28) in the blade assemblies 4100, 4200 may be implemented to attain the desired conditioning of the product, including, for example, a desired cutting, scoring, tenderizing, or the like.

The example of the cartridge assembly 400 includes the cutting blade assembly 4100, the traction blade assembly 4200, a comb assembly 4180, 4280, and the cartridge base 460. The comb assembly 4180, 4280 may include stripper combs that are formed of heavy duty stainless steel. It is noted that the order of the cutting blade assembly 4100 and traction blade assembly 4200 may be switched such that, for example, the traction blade assembly 4200 is provided in the front and the cutting blade assembly 4100 is provided in the rear. The blade assemblies 4100, 4200 include a plurality of cartridge rods 4130, 4230. Furthermore, as noted above, different types of blade configurations may be used for the blades 510, 610 to obtain desired conditioning of the products, including, for example, cutting, scoring, tenderizing, or the like. The blades 510, 610 may be configured to provide varying levels of tenderizing (e.g., light tenderizing, medium tenderizing, heavy tenderizing, or the like), cutting (e.g., different dimension of cuts), scoring (e.g., different degrees of penetration), or the like.

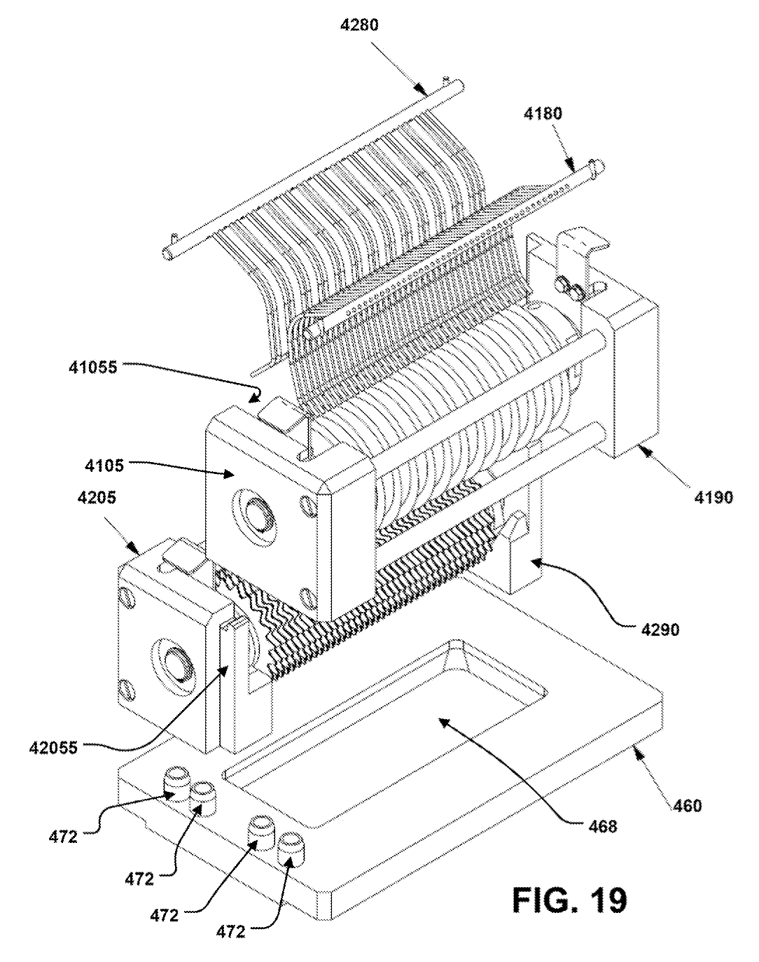

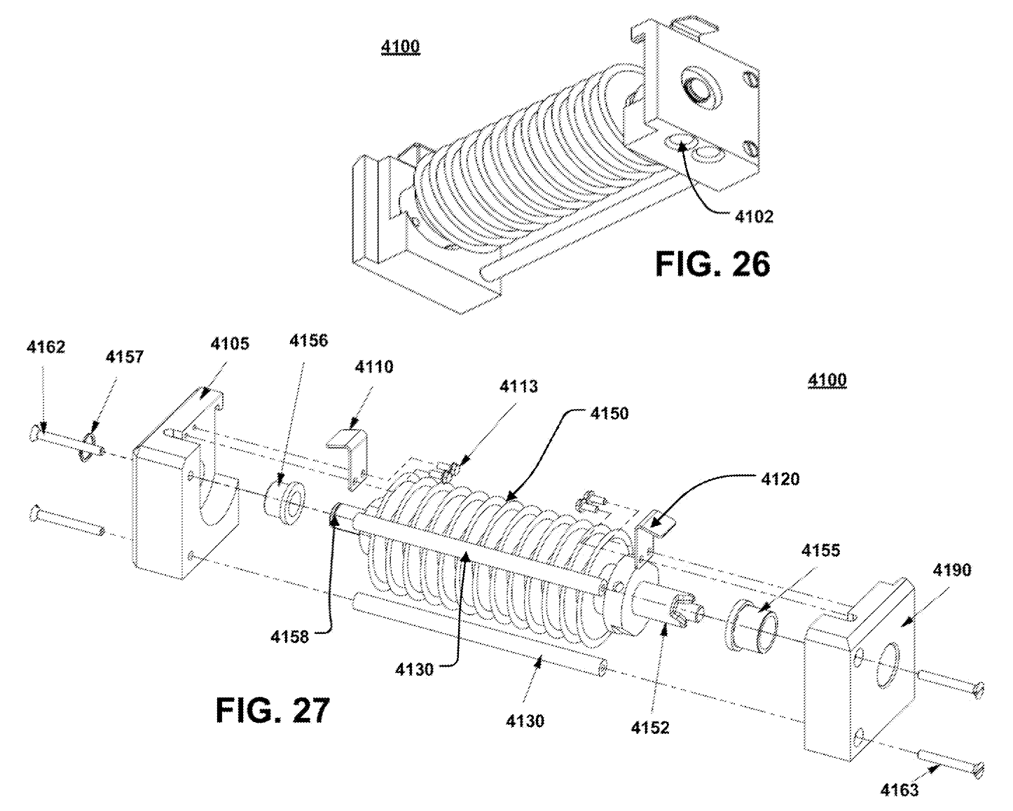

FIG. 19 shows an exploded view of the cartridge assembly 400, according to principles of the disclosure. As seen, the blade assemblies 4100, 4200 may be configured to be substantially independent of each other, allowing for independent removal and/or replacement of either (or both) blade assemblies 4100, 4200 in the cartridge assembly 400. The traction blade assembly 4200 may include a cartridge mount 4205, which may include a tongue (or groove) 42055 for engaging a corresponding groove (or tongue) 41055 on a cartridge mount 4105. The cartridge mounts 4105, 4205, each may include one or more openings 4102, 4202 (shown in FIGS. 21, 26) for receiving a corresponding one or more cartridge mount pins 472 provided on the cartridge base 460, for example, to prevent incorrect installation of the blade assemblies 4100, 4200. The cartridge base 460 has an aperture 468 for allowing conditioned (for example, tenderized or cubed) meat products to pass down on to, for example, a slide, a conveyor belt, a table top, or the like.

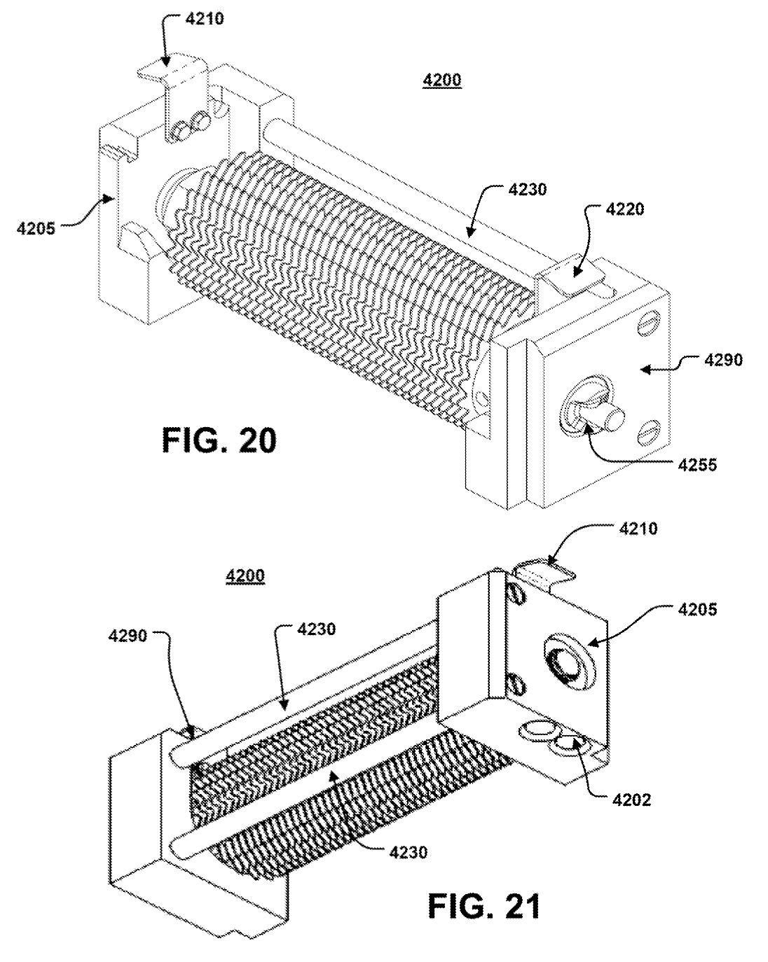

FIG. 20 shows a perspective view of the traction knit cubing blade assembly 4200, with the cartridge shaft 4255 visible. The shown blade configuration may slice a meat product received from the chute 210 into strips.

FIG. 21 shows a perspective bottom view of the traction knit cubing blade assembly 4200, showing a plurality of openings 4202 for receiving corresponding cartridge mount pins 472 on the cartridge base 460.

FIG. 22 shows an exploded view of the traction knit cubing blade assembly 4200, according to principles of the disclosure. The traction blade assembly 4200 includes, a traction blade 4250, the cartridge mounts 4205, 4290, a pair of shaft guides 4252, 4256, which may be inserted into a respective opening in the cartridge mounts 4205, 4290. The traction blade assembly 4200 further includes the pair of guide handles 4210, 4220, the cartridge rods 4230, and a shaft fastener 4257. The shaft fastener 4257 may include, for example, a retaining ring, a screw, a nut, a lynch pin, or the like. The guide handles 4210, 4220 may be affixed to the cartridge mounts 4205, 4290, respectively, by means of fasteners 4282. The cartridge mounts 4205, 4290, may be affixed to the cartridge rods 4230 by means of fasteners 4202, 4292, respectively. The fasteners 4282, 4205, 4290, may include, for example, bolt-nut combinations, screws, or the like. The ends of the cartridge shaft 4255 may be inserted through and rotationally supported by the shaft guides 4252, 4256. The shaft guides 4252, 4256 may include, for example, plastic flange bearings. The traction blade assembly 4200 may be assembled and secured in an operational condition (e.g., shown in FIG. 20) by, for example, affixing the shaft fastener 4257 to the end of the cartridge shaft 4255 that is proximate to the shaft guide 4252. The end of the cartridge shaft 4255 may include, for example, a channel (or, e.g., a thread, an opening, or the like) 4258 for engaging the shaft fastener (e.g., retaining ring) 4257.

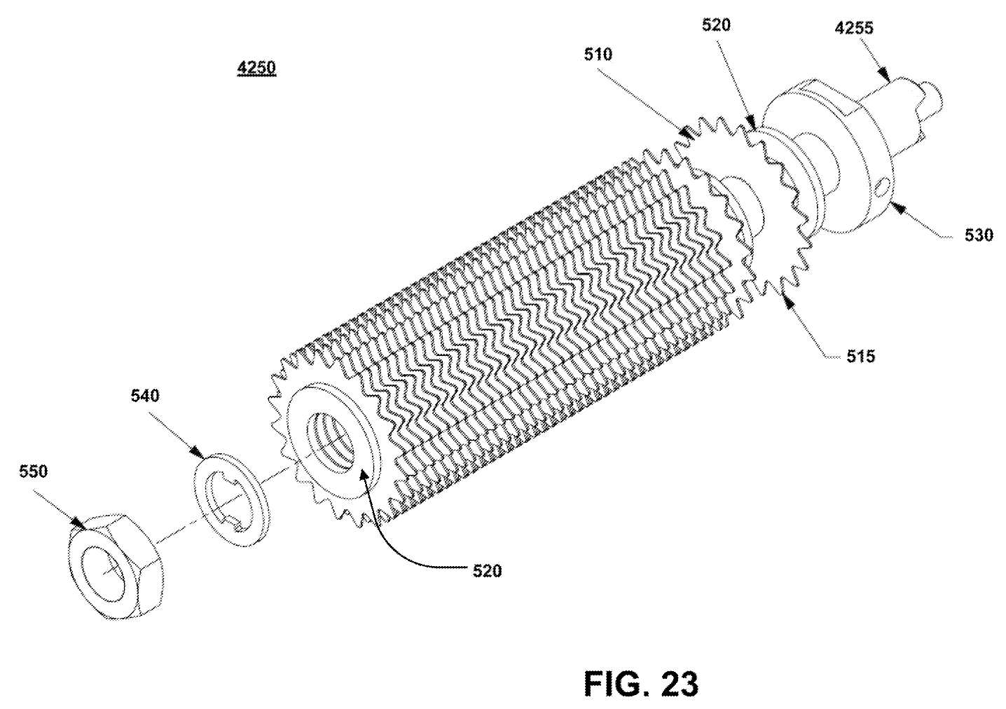

FIG. 23 shows an exploded view of a traction knit cubing blade 4250, according to principles of the disclosure. The traction blade 4250 includes the cartridge shaft 4255, a plurality of traction knit cubing blades (for example, forty) 510, a plurality of spacers (for example, forty-one) 520, a retainer 530, a keyed washer 540 and a fastener 550 (e.g., a nut, a bolt, a screw, or the like), which may be fastened to a fastening section (e.g., a threaded section, not shown) of the cartridge shaft 4255. The fastening section may include, for example, standard RH or LH threads which are configured to constantly tighten via friction of the blades, depending on the direction of rotation of the blades 510. The keyed washer 540 may stop any frictional rotation from reaching the fastener 550, thereby preventing loosening of the fastener 550. Each of the blades 510 may include one or more channels 512 (shown in FIG. 24) to lockably couple the blades 510 to the cartridge shaft 4255, so that the tips 515 of the blades 510 align, as seen in FIG. 23, and the blades 510 are prevented from rotating with regard to the cartridge shaft 4255.

FIG. 24 shows an example of the traction knit cubing blade 510, according to principles of the disclosure. It is noted that other configurations for the blades 510 may be equally implemented, depending on the desired performance of the cartridge assembly 400. For instance, the blades 510 may be supplemented with, or replaced with tenderizing and/or scoring blades. The tips 515 of the blade 510 may be configured to have angles A1, A2, and A3. Furthermore, the traction knit cubing blade may include, for example, three channels 512, which may be configured at angles A4, A5. According to a non-limiting example of the blade 510, the angles A1, A2, A3, A4, A5, may have values of, for example, about 54°, about 18°, about 27°, about 10°, and about 10°, respectively.

FIG. 25 shows an alternative example of the traction knit cubing blade 510, according to principles of the disclosure. As seen, the tips 515 may be configured with a directional bias. The perimeters of the blades 510 may be sharpened, for example, similar to the slitter blades 610 to deliver increased tenderization by cutting through more connective tissue.

FIG. 26 shows a perspective bottom view of the rotary (round) cutting blade assembly 4100, including the openings 4102, according to principles of the disclosure.

FIG. 27 shows an exploded view of the cutting blade assembly 4100, according to principles of the disclosure. The cutting blade assembly 4100 includes a cutting blade 4150, the cartridge mounts 4105, 4190, a pair of shaft guides 4156, 4155, which may be inserted into a respective opening in the cartridge mounts 4105, 4190, the pair of guide handles 4110, 4120, the cartridge rods 4130, and a fastener 4157. The guide handles 4110, 4120 may be affixed to the cartridge mounts 4105, 4190 by means of fasteners 4113. The cartridge mounts 4105, 4190 may be affixed to the cartridge rods 4130 by means of fasteners 4162, 4163, respectively. The fasteners 4113, 4162, 4163, may include, for example, bolt-nut combinations, screws, or the like. The ends of the cartridge shaft 4152 may be inserted through and rotationally supported by the shaft guides 4156, 4155. The shaft guides 4156, 4155 may include, for example, plastic flange bearings. The cutting blade assembly 4100 may be assembled and secured in an operational condition (shown in FIG. 26) by, for example, affixing a shaft fastener 4157 to the end of the cartridge shaft 4152 that is proximate to the shaft guide 4156. The shaft fastener 4157 may include, for example, a retaining ring, a screw, a nut, a lynch pin, or the like. The end of the cartridge shaft 4152 may include, for example, a channel (or, e.g., a thread, an opening, or the like) 4158 for engaging the shaft fastener 4157 (e.g., a nut, a bolt, a screw, or the like).

FIG. 28 shows an exploded view of the cutting blade 4150, according to principles of the disclosure. The cutting blade 4150 includes the cartridge shaft 4152, a plurality of slitter cutting blades (for example, thirteen) 610, a plurality of spacers (for example, fourteen) 608, a retainer 605, a spacer 620, a keyed washer 630 and a fastener 640, which may be fastened to a fastening section (e.g., a threaded section, not shown) of the cartridge shaft 4152. The fastening section may include, for example, standard RH or LH threads which are configured to constantly tighten via friction of the blades, depending on the direction of rotation of the blades 610. The keyed washer 630 may stop any frictional rotation from reaching the fastener 640, thereby preventing loosening of the fastener 640.

It is noted that other configurations for the slitter cutting blades 610 may be equally implemented, depending on the desired performance of the cartridge assembly 400. For instance, the slitter cutting blades 610 may be supplemented or replaced with tenderizing and/or scoring blades.

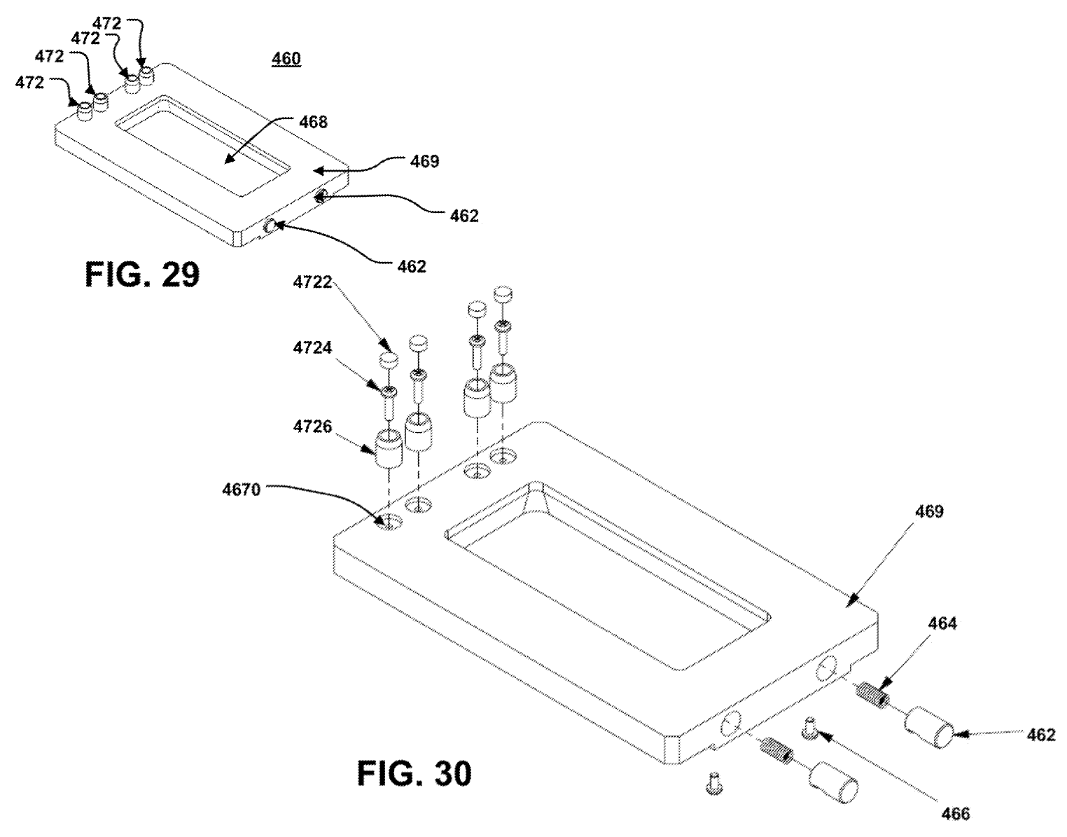

FIG. 29 shows a perspective view of the cartridge base 460, according to principles of the disclosure. The cartridge base 460 may include a pair of the spring pins 462, a pair of cartridge mount pins 472 for each of the cartridge mounts 4105, 4205, and a frame 469, which has the opening 468. The cartridge base 460 may support all of the available matched blade sets 4100, 4200, including, for example, knit cubing blade sets, scoring blade sets, perforating blade sets, slitting blade sets, and the like.

FIG. 30 shows an exploded view of the cartridge base 460. In addition to the spring pins 462, springs 464, and spring pin stroke limiters 466, described earlier with reference to FIG. 15, each of the cartridge mount pins 472 may include a cartridge pin plug 4722, a screw 4724, and a cartridge pin 4726, which may be seated in a recess 4670 in the cartridge base 460.

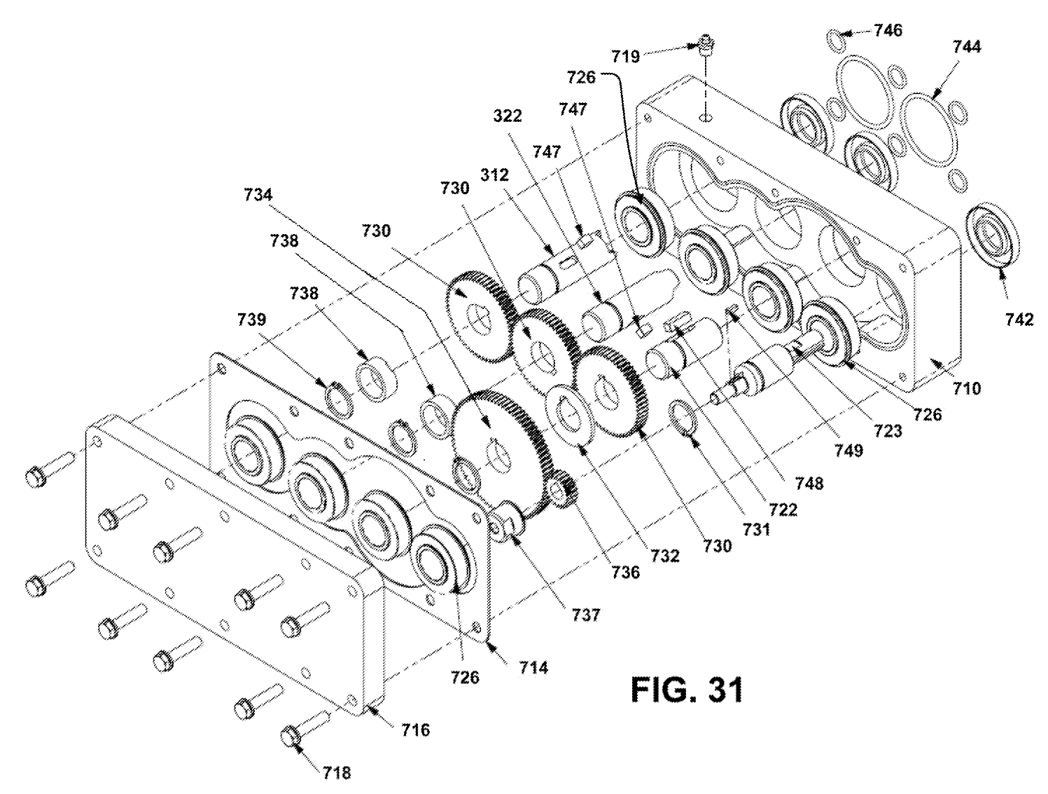

FIG. 31 shows an exploded view of an example of the gearbox assembly 700, according to principles of the disclosure. The gearbox assembly 700 includes a gearbox base 710, a gasket 714, a cover 716, a plurality of fasteners 718 (e.g., screws, bolts, washers, nuts, or the like), a grease fitting 719, the drive shafts 312, 322, an idler shaft 722, an inlet shaft 723, a plurality of bearings 726 (e.g., eight), a plurality of spur gears 730, 732, 734, a shaft end inlet 737, a plurality of shaft spacers 738, a plurality of fasteners 739 (e.g., four retaining rings), a plurality of seals 742 (e.g., three double lip seals), a plurality of rings 744, 746 (e.g., O-rings), and a plurality of keys 747, 748, 749. The drive shafts 312, 322 may be substantially the same. Each of the drive shafts 312, 322, the idler shaft 722 and inlet shaft 723 may be configured to receive one of the keys 747, 748, 749. In particular, the drive shafts 312, 322 may be configured to each receive a key 747; the idler shaft 722 may be configured to receive the key 748; and the inlet shaft 723 may be configured to receive the key 749. The various components of the gearbox assembly 700 may be assembled as illustrated in FIG. 31.

FIG. 32 shows a process for controlling supply of electric power to the motor circuit (not shown), according to principles of the disclosure. Referring to FIGS. 1 and 32, the position of the guard assembly 200 may be detected and monitored by means of the magnet assembly 200 (Step 3210). A determination may be made as to whether the guard assembly 200 is moved or improperly installed (Step 3220). If a determination is made that the guard assembly 200 has been moved by more than a predetermine threshold (e.g., about 2 mm, or more), a decision may be taken that the guard assembly 200 is not properly installed or that the guard assembly 200 has been removed from the food conditioner 100 (NO at Step 3220), otherwise the process may continue to monitor the position of the guard assembly 200 (YES at Step 3220).

If a decision is taken that the guard assembly 200 has been removed, or that the guard assembly 200 is not properly positioned in the food conditioner (NO at Step 3220), then the electric power that is supplied to the motor circuit (shown in FIG. 4) may be ceased or cut off (Step 3230). The electric power may not be supplied to the motor circuit until a determination is made that the guard assembly 200 has been properly installed (YES at Step 3240) and that the actuator 160 enabling operation of the food conditioner 100 (e.g., “START” button) has been actuated (YES at Step 3250). In this regard, if a determination is made that the guard assembly 200 has been properly installed in the food conditioner 100 (YES at Step 3240), then the determination may be made whether, e.g., the “START” actuator 160 has been depressed (Step 3250), otherwise the process continues to monitor the position of the guard assembly 200 (NO at Step 3240 or NO at Step 3250, then Step 3210). When a determination is made that, e.g., the “START” actuator 160 has been depressed (YES at STEP 3250), electric power supply to the motor circuit may be enabled (Step 3260), thereby enabling operation of the food conditioner 100.

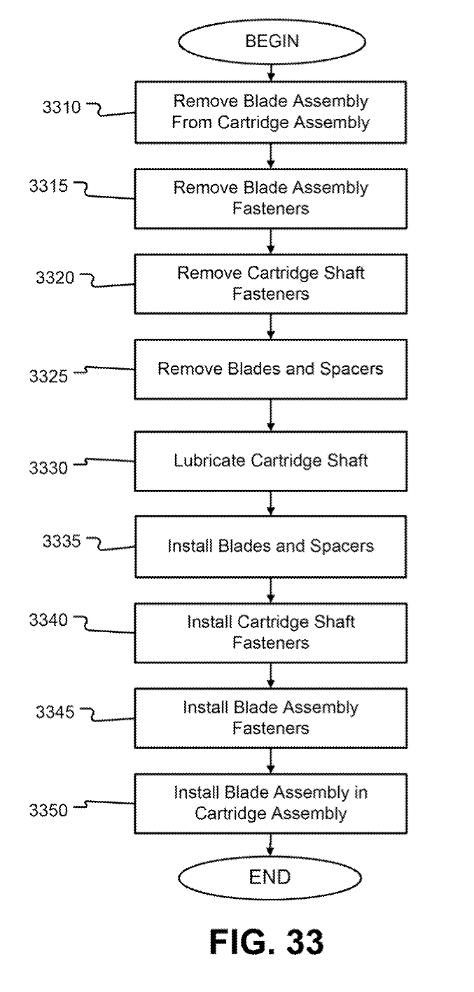

FIG. 33 shows a process for cleaning or replacing parts of the cutting blade assembly 4100 or the traction blade assembly 4200, according to principles of the disclosure. While the process shown in FIG. 33 may be used for cleaning or replacing parts of both the cutting blade assembly 4100 or the traction blade assembly 4200, the following example is discussed with respect to the cutting blade assembly 4100, with an understanding that the process applies equally with regard to the traction blade assembly 4200.

Referring to FIG. 27 (or FIG. 22) and FIG. 33, the blade assembly 4100 (or 4200) may be removed from the cartridge assembly 400 (Step 3310). Then, the blade assembly fasteners 4162 may be removed from the blade assembly 4100 (Step 3315). The cartridge shaft fasteners 4157, 640, 630, 620 (shown in FIG. 28), and the cartridge mount 4105 may then be removed from the cartridge shaft 4152 (Step 3320), as understood by those having ordinary skill in the art. The blades 610 and spacers 608, 620 (shown in FIG. 28), may be removed from the cartridge shaft 4152 (Step 3325). The cartridge shaft 4152 may be lubricated with, for example, a spray mineral oil lubricant (Step 3330).

To reassemble the blade assembly 4100 (or 4200), the blades 610 and spacers 608, 620 may be installed back on to the cartridge shaft 4152 (Step 3335). If a determination is made that any of the blades 610 and/or spacers 608, 620 should be replaced, new blades 610 and/or spacers 608/620 may be installed on the cartridge shaft 4152 (Step 3335). The cartridge shaft fasteners 4157, 640, 630, 620 (shown in FIG. 28), and the cartridge mount 4105 may then be installed on the cartridge shaft 4152 (Step 3340). Then, the blade assembly fasteners 4162 may be installed in the blade assembly 4100 (Step 3345), and the blade assembly 4100 installed back in the cartridge assembly 400 (Step 3350).

According to an aspect of the disclosure, a computer readable medium may be provided, comprising a computer program that is tangibly embodied in the computer readable medium. The computer program may include a code section or code segment that, when executed by the controller (not shown), may cause each of the Steps 3210 through 3260 to be carried out.

While the disclosure provides an example of a cartridge assembly 400 that includes a pair of blade assemblies 4100, 4200, it is noted that any number of blade assemblies may be included without departing from the scope or spirit of the disclosure, as will be readily understood by those having ordinary skill in the art after reading the instant specification.

Furthermore, the disclosure is not limited to a single cartridge assembly 400, but, instead, the food conditioner 100 may include two or more cartridge assemblies. In this regard, a plurality of chutes 210 may be included, one for each cartridge assembly. In this regard, a single guard assembly 200 may be used with the plurality of cartridge assemblies. The single guard assembly 200 would include a plurality of chutes, each aligned with a respective cartridge assembly. Generally, one chute embedded in the guard assembly 200 may accommodate all of the various cartridge assembly styles that a specific operation may want to run through the food conditioner 100.

While the disclosure has been described in terms of exemplary embodiments, those skilled in the art will recognize that the disclosure can be practiced with modifications in the spirit and scope of the appended claim, drawings and attachment. The examples provided herein are merely illustrative and are not meant to be an exhaustive list of all possible designs, embodiments, applications or modifications of the disclosure.

1. A food conditioner, comprising:
a primary guard that is configured to be removable; and
a drive train network that is configured to automatically unlatch when the primary guard is removed,
wherein the primary guard includes a guard partition that forces engagement of a tapered coupling drive.

2. The food conditioner according to claim 1, further comprising:
a cartridge assembly that is configured to separate from the food conditioner,
wherein the cartridge assembly is spring-loaded, and
wherein the cartridge assembly is further configured to engage the coupling drive under force from the guard partition.

3. The food conditioner according to claim 2, wherein the guard partition comprises an angled wedge portion that temporarily contacts a portion of the cartridge assembly when the primary guard is removed from or installed in the food conditioner.

4. The food conditioner according to claim 1, wherein the cartridge assembly comprises a pair of matched blade assemblies.

5. The food conditioner according to claim 4, wherein the cartridge assembly comprises at least one of:
a tenderizing blade assembly;
a scoring blade assembly;
a cutting blade assembly;
a traction knit cubing blade assembly; and
a traction blade assembly.

6. The food conditioner according to claim 4, wherein at least one of the pair of matched blade assemblies comprises a cartridge shaft having a tapered end to engage the coupling drive.

7. The food conditioner according to claim 1, wherein the coupling drive comprises at least one drive shaft having a tapered end.

8. The food conditioner according to claim 2, wherein the cartridge assembly comprises a cartridge base, the cartridge base comprising:
a pusher pin that is configured to store potential energy when the cartridge assembly is in a substantially operational position and release the potential energy when the primary guard is moved from a substantially operational position.

9. The food conditioner according to claim 1, further comprising:
a controller that is configured to cease supply of power to a drive motor when the primary guard is moved from a substantially operational position.

10. The food conditioner according to claim 9, further comprising:
a magnet assembly that is configured to detect when the primary guard is moved from the substantially operational position.

11. The food conditioner according to claim 9, further comprising:
a read switch and magnet assembly that is configured to detect when the primary guard is moved from the substantially operational position and send a signal to the controller.

12. A food conditioner, comprising:
a removable primary guard that includes a chute which is configured to receive a product;
a cartridge assembly that includes a pair of matched blade assemblies that are configured to receive the product from the chute; and
a drive train that is configured to automatically unlatch when the primary guard is removed,
wherein the primary guard includes a guard partition that forces engagement of a tapered coupling drive, and
wherein the cartridge assembly is further configured to engage the coupling drive under force from the guard partition.

13. The food conditioner according to claim 12, wherein the guard partition comprises an angled wedge portion that temporarily contacts a portion of the cartridge assembly when the primary guard is removed from or installed in the food conditioner.

14. The food conditioner according to claim 12, wherein at least one of the pair of blade assemblies comprises a cartridge shaft having a tapered end to engage the coupling drive.

15. The food conditioner according to claim 12, wherein the coupling drive comprises at least one drive shaft having a tapered end.

16. The food conditioner according to claim 12, wherein the cartridge assembly comprises a cartridge base, the cartridge base comprising:
a pusher pin that is configured to store potential energy when the cartridge assembly is in a substantially operational position and release the potential energy when the primary guard is moved from a substantially operational position.

17. The food conditioner according to claim 12, further comprising:
a controller that is configured to cease supply of power to a drive motor when the primary guard is moved from a substantially operational position.

18. The food conditioner according to claim 17, further comprising:
a magnet assembly that is configured to detect when the primary guard is moved from the substantially operational position.

19. A food conditioner, comprising:
a housing configured to receive a primary guard and a cartridge assembly, which includes a pair of matched blade assemblies; and
a drive train network that includes a coupling drive which is configured to automatically unlatch from the cartridge assembly when the primary guard is removed.

20. The food conditioner according to claim 19,
wherein at least one of the pair of matched blade assemblies is selected from:
a tenderizing blade assembly;
a scoring blade assembly;
a cutting blade assembly;
a traction knit cubing blade assembly; and
wherein the drive train network comprises a keyed washer.
